(19) United States
(12) Patent Application Publication
(10) Pub. No.: US 2005/0111405 A1
(43) Pub. Date: May 26, 2005

(54) Interference cancellation method and apparatus

(76) Inventor: Emmanuel Kanterakis, North Brunswick, NJ (US)

Correspondence Address: EMMANUEL KANTERAKIS, 740 HOOVER DRIVE, NORTH BRUNSWICK, NE, 08902, US

(21) Appl. No.: 10/995,785

(22) Filed: Nov. 23, 2004

Related U.S. Application Data
(60) Provisional application No. 60/525,088, filed on Nov. 25, 2003.

(51) Int. Cl. H04Q 7/00

(52) U.S. Cl. 370/328

(57) ABSTRACT

A Multi-User Detection device and method for DS-CDMA to allow enhanced signal reception under Multi-User Interference (MUI) at either the Remote Station or the Base Station is disclosed. The method includes the steps of relaying current channelization code use at Base Stations to Remote Stations operating in the vicinity of the Base Stations. This information is used by an MUD device at the Remote Station, to improve its ability to separate signals transmitted from different Base Stations. The downlink channelization code information is used to recreate the interference received by all neighboring Base Stations transmissions at the Remote Station. The same method can be applied at the Base Station side. The Uplink Channelization Code Usage information is relayed to each Base Station from its neighboring Base Stations. Recreating the total Remote Station interference at the Base Station allows a multistage interference cancellation based MUD to enhance its capability of receiving Remote Stations in its coverage area.

### RELATED APPLICATIONS

This application is related and claims the benefits of U.S. provisional patent application APPL No. 60/525,088, FILING DATE Nov. 25, 2003 and entitled “Downlink interference cancellation method and apparatus. The content of this provisional application is incorporated herein as reference.

### BACKGROUND OF THE INVENTION

1. Technical Field

The present invention relates to an improved interference cancellation method for use in wireless communications systems employing code division multiple access techniques.

2. Background Art

Code Division Multiple Access (CDMA) communications allow different users to communicate over a common medium at the same time by using user specific codes embedded into their signals in order to differentiate from each other's transmissions. The user codes are normally designed to be orthogonal to each other in time. When CDMA is employed for sending information from a Base Station to Remote Terminals, the codes used are orthogonal to each other and are in general aligned in a way that the transmissions to different Remote Terminals over any symbol interval are also orthogonal to each other. Though this orthogonality is maintained when the transmission is over a medium that allows the signals to arrive at the receiver undistorted, wireless channels in general distort the transmitted signals so when they arrive at the receiver they are no longer orthogonal to each other. In other cases, the transmitted signals though transmitted using different codes, these codes are not necessarily made to be orthogonal to each other. This allows the system to employ more codes than it would otherwise since the number of orthogonal codes in the system depends on the ratio of the transmission bandwidth to the symbol rate. The drawback is the absence of orthogonality between transmitted signals however results in higher error rates and thus in a lower system capacity. Receiver structures based of conventional Matched Filter reception do not work well in these scenarios. Matched Filters alone are not able to separate the interference caused by either the channel disturbance or the use of non-orthogonal codes. Irrespectively of the code structure used to transmit the information, it is desirable to separate the signals transmitted to different Remote Stations. Special receivers structures are often employed which allow the system to alleviate some of the effects caused by the channel distortion. A RAKE receiver combines multipath components by adding a number of delayed and weighted versions of the received signal. This in effect matches the receiver to the received symbols rather to the transmitted one. Estimates of the channel response are required to form a RAKE receiver. Though this receiver collects more energy in forming its decision variables and thus reduces the underlying bit error rate, the signals meant for different remote terminals may still present substantial interference. Further improvements can be obtained by employing a receiver structures that are more capable than RAKE receivers. In case the transmitted symbols are orthogonal to each other, a channel equalizer can be used to remove most of the effects of the channel and thus restore the original orthogonality between signals. Restoring the orthogonality between signals means that using the orthogonal properties of the codes the signals can be easily separated from each other. In case the transmitted signal are not originally orthogonal to each other, other more complex techniques need to be employed. The use of orthogonality between signals from the Base Station to the Remote Station provides easy signal separation to a number of Remote Stations operating in proximity to their primary Base Station. In the case however, the Remote Station is not in proximity to its primary Base Station, it is likely that it will receive strong transmissions from a number of neighboring Base Stations. These transmissions cannot be made orthogonal to each other, thus orthogonality between signals transmitted from a single Base Station are of not much help in such situations. It is also possible that the Remote Station will be connected to a number of neighboring Base Stations at the same time using soft-handoff. Because of the different propagation delays to different Remote Stations, transmissions from different Base Stations cannot be made orthogonal to each other. Channel equalizers can be used to orthogonalize receptions from each Base Station, however, they cannot orthogonalize receptions from different Base Stations. Orthogonalizing receptions from each Base Station and then combining the resulting waveforms in some fashion will provide some gains, however, those gains will be limited since the receiver will in general behave as a RAKE receiver. The problem will be further exacerbated if the transmissions to different Remote Stations from each Base Station are not originally orthogonal to each other.

A similar problem is encountered when data is transmitted form the Remote Stations to the Base Stations. In general, these transmissions are not orthogonal to each other though Remote Users belonging to a single Base Station can be aligned using some form of a closed loop control to adjust their transmission delays. In either case, signals received at a Base Station from Remote Stations having other Base Stations as their primary Base Station, in general cannot be received orthogonally. If the interference received from Remote Stations operating in neighboring cells cannot be separated from the signal received from in-cell Remote Stations, only a limited amount of improvement can be achieved using any interference reduction techniques.

Various techniques have been developed to deal with single cell interference. For example, a number of Base Station-based techniques use the signals arriving from Remote Stations in its own Base Station to perform some type of interference cancellation. Since the codes employed by the Remote Stations in a certain cell are known to the Base Station in that cell, these codes can be used to derive Base Station based receiver structures which can effectively remove the interference between signals. Examples of such structures can be found in U.S. Pat. No. 05,757,791 and U.S. Pat. No. 05,644,592. There are also receiver structures that are based on whitening the multi-user interference and do not require knowledge of the codes used. At the Remote Stations most of the interference cancellation is accomplished with channel equalization.

There have been many proposed interference cancellation schemes for DS-CDMA based systems where multi-user interference is the primary capacity limiting factor. Most of those schemes, however, have been proposed for reducing the in-cell multi-user interference at the Base Station. The main reason for this trend is the heavy computational load required by most proposed interference cancellation techniques. Since cost is a major factor in any user equipment, complex multi-user interference cancellation schemes have not been proposed for the Remote Stations.

So far, interference cancellation schemes at the user equipment have dictated the system to be designed in ways that made those schemes somewhat reasonable from a cost perspective. Furthermore, though better schemes can be used for a further increase in system capacity, that additional capacity has been traded for reducing system complexity.

The disadvantages of having a MUD system at a Remote Station are: (a) complexity is a primary bigger issue for Remote Stations; (b) the information on codes used within the cell by other users are not known at a Remote Station; (c) the information on codes used by users in neighboring cells are not known at a Remote Station Removing these disadvantages of the Remote Station will render many MUD algorithms previously applicable only for Base Stations, applicable to the Remote Stations as well. The complexity issue could be tackled by taking advantage of a special property of most CDMA based cellular systems. Under this property, the various downlink signals from a Base Station are transmitted chip synchronously and symbol orthogonal using Walsh/Hadamard codes. The composite signal though scrambled by some cell specific scrambling code, scrambling codes do not alter the original signal orthogonality between different signals. This property can be used to develop Remote Station based interference receiver structures that have a reasonable complexity. The orthogonality between different user signals enables the use of efficient receivers to demodulate all the signals transmitted for all the Remote Station in the cell. This is possible because all the symbols that are transmitted in parallel can be demodulated with the use of a Fast Walsh/Hadamard Transform. Fast Walsh/Hadamard Transforms (FWHTs), unlike Fast Fourier Transforms (FFTs), are much simpler to implement since while the same type of structure as FFTs, they do not require any multiplications. Clearly, issues such as variable data rates, which might translate to variable spreading factors for each user and the variability of data rates between different users and Discontinued Transmission (DTX) will need to be addressed. In cases where the spreading factors of the transmitted symbols do not change very often, the notion of demodulating all signals becomes more palatable. Receiver structures such as RAKE reception can be easily incorporated with the Walsh/Hadamard transforms for reception of multiple orthogonally transmitted signals. It is also possible to incorporate channel equalizers in either chip or symbol domain with Walsh/Hadamard transforms.

The second and third issues above could be addressed in different ways. One way could be to incorporate new downlink channels at each Base Station to relay the information about the spreading codes currently in use by Remote Stations communicating with each Base Station. This capability can be easily incorporated into the system by using any available common downlink channel. The information about the spreading codes will need to be broadcast throughout the cell in order to be reachable by all Remote Stations anywhere inside the cell. There is normally a multitude of common channels that can be allocated for different usages. One of them or even a portion of a common channel could be used to relay the current Channelization Code Usage Information (CCU) data. In case a small number of Remote Stations utilize a MUD on the downlink, it might be preferable depending on the cell geometries involved to use a dedicated channel or send the CCU information as in-band signaling in the same channel sent to the Remote Station employing MUD. Either way, the transmission of CCU data is an issue that needs to be addressed optimally. Due to the high transmission power required to reach the edge of a cell reliably, broadcast type transmissions are very costly in CDMA systems. It is therefore possible to expect that such a channel will require heavy forward error correction coding and some other means to increase the reception diversity. For these reasons, we will also propose other alternate methods. These methods do not require that all the codes in use within the cell be identified via signaling. Since strong received codes at a Remote Station are easily identifiable, it could be sufficient to achieve considerable interference cancellation gains by simply using channelization code information derived locally at the Remote Stations. Therefore, another method proposed here is to detect the downlink code use by analyzing the downlink transmissions from all neighboring cells locally at the Remote Stations. At a minimum, the synchronization and broadcast channels should be easily detectable. In many systems it is also a requirement for Remote Stations to be able to receive synchronization and common pilot signals from different Base Stations at the same time. Having that capability, the additional HW complexity to estimate the use of other codes from a given Base Station should be reasonable. Furthermore, the use of Hadamard Transforms would allow for bulk processing where all the orthogonal transmitted downlink signals under a single scrambling (cover) code could be demodulated. The detection parameters used could vary given the power a code is transmitted at. Channels having large power would be much easier identifiable than lower power channels. A power measurement over some time on those channels would be sufficient to detect their presence. Lower power channels might require either longer observation times to accumulate enough despread signal energy or employ other detectability criteria as for example Frame Synchronization. Tracking the downlink common pilot channels could afford the use of coherent detection techniques on known transmitted symbols such as dedicated pilot signals transmitted with most downlink channels.

It should be noted that, performing interference cancellation on the dedicated pilots signals only received on the downlink channels could present a substantial capacity increase on the overall system. Dedicated pilot channels constitute a substantial portion of the downlink transmitted power budget. Also, since the transmitted pilot symbols are known beforehand, their demodulation could be carried out over times longer than single symbol intervals. In this case, additional coherent processing gain could be obtained. This would in effect reduce their interference contribution when incorporated into the proposed algorithms. Integrating over longer that symbol intervals will increase processing delay and buffering especially for long symbols.

Performing downlink code use estimation utilizing signal presence estimation on different channels could save considerable system capacity at the expense of additional HW complexity at the Remote Station. The drawback to this option is that in case there are a large number of channels on the downlink, the required processing at the Remote Station could be large.

### SUMMARY OF THE INVENTION

A Multi-User Detection device and method for Direct Sequence—Spread Spectrum (DS-SS) communications to allow enhanced signal reception under Multi-User Interference (MUI) at either the Remote Station or the Base Station site is disclosed. The method includes the steps of relaying Current Channelization Code Use at neighboring Base Stations to one or multiple Remote Stations operating in the vicinity of the Base Stations. This information is then used by the Remote Stations to operate a MUD device in order to improve upon the Remote Station's ability to separate signals transmitted for different Remote Stations. This signal separation will in turn improve the Remote Station's capability in receiving its own data. The Channelization Code information of the signals transmitted on the Downlink by neighboring Base Stations (including the Remote Station's primary Base Station) is used to recreate the interference received by all neighboring Base Stations transmissions at the Remote Station. Recreating the interference at the Remote Station in a multistage parallel interference cancellation MUD method allows for easy and effective interference cancellation. The same method can be applied at the Base Station side. The Uplink Channelization Code Usage information can be relayed to a Base Station from its neighboring Base Stations. This information transfer can be done using the radio network controllers (RNCs) to which the Base Stations are connected. A Base Station is then able to recreate the uplink interference received from Remote Stations residing within its coverage area as well as interfering Remote Stations located in the coverage area of neighboring Base Stations. Recreating the total Remote Station interference at the Base Station allows a multistage interference cancellation based MUD to enhance its capability of receiving Remote Stations in its own coverage area.

### BRIEF DISCRIPTION OF THE DRAWINGS

FIG. 1 is a general system functional schematic where a Channelization Code Usage Retrieval Unit (CCURU) unit is used to retrieve the channelization code information needed for the operation of the Multi-User Detector (MUD) unit.

FIG. 2 is a system configuration functional schematic where an explicit physical channel is setup to transmit Channelization Code Usage (CCU) data.

FIG. 3 is a system configuration functional schematic where the Channelization Code Information data is transmitted to Remote Station j using embedded signaling.

FIG. 4A is a functional schematic for the first stage of a Multi-Stage Multi-User detector employing Fast Walsh/Hadamard Transforms to demodulate signals received at a Remote Station from two different Base Stations.

FIG. 4B is a functional schematic for the first stage of a Multi-Stage Multi-User detector employing channel filtering (RAKE reception) and Fast Walsh/Hadamard Transforms to demodulate signals received at a Remote Station from two different Base Stations.

FIG. 5 is a functional schematic for the first two stages of a Multi-Stage Multi-User detector employing Fast Walsh/Hadamard Transforms to demodulate signals received at a Remote Station from two different Base Stations.

FIG. 6 is a general system functional schematic where CCURUs are used to enable retrieval of uplink channelization code information required by the Base Station MUD modules. The CCURUs collect/retrieve information from uplink received radio signals and information from neighboring Base Stations and RNCs.

FIG. 7 is a general system functional schematic where CCURUs are used to enable retrieval of uplink channelization code information required by the Base Station MUD modules. The CCURUs collect/retrieve information from uplink received radio signals and information from neighboring Base Stations and RNCs.

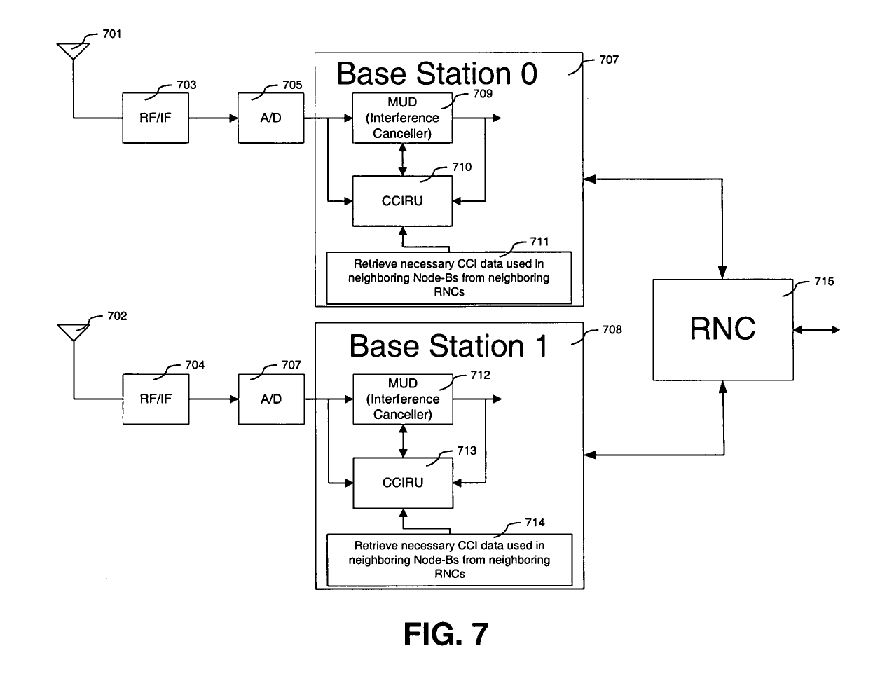

### DETAILED DESCRIPTION OF THE PREFERED EMBODIMENT

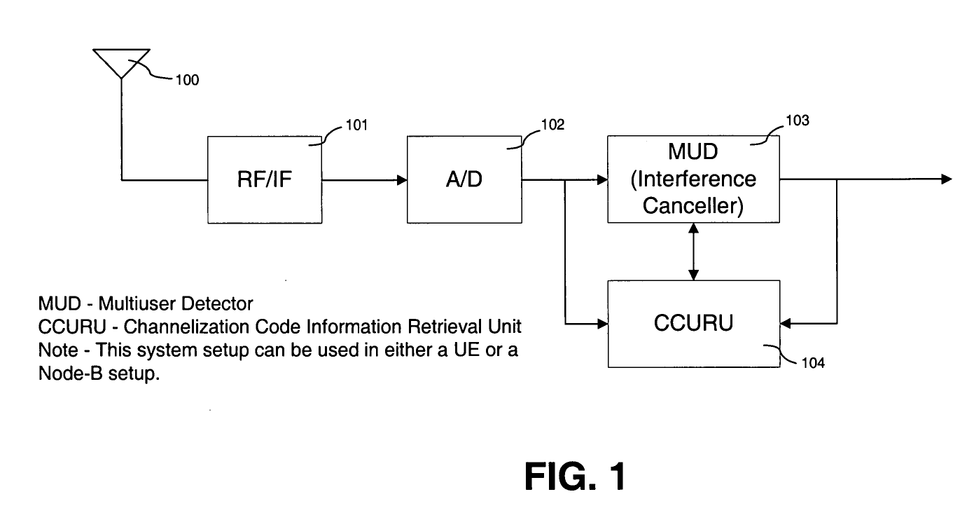

A general system functional configuration of the disclosed method is shown in FIG. 1. As shown in FIG. 1 there are two main modules required for the system. One is the Multi-User Detector (MUD) 103 module and the CCU Retrieval Unit (CCURU) 104. The received signals at the antenna input 100 are RF filtered 101, Analog to Digital (A/D) 102 converted and then supplied to the MUD 103 and CCURU 104 modules. The connections shown attached to the MUD 103 and CCURU 104 modules are meant to demonstrate the different possible signal flows required to and between the two modules. Depending on the way the system is operated, a certain flow might not be required. The main different ways the system could be operated are a follows:

(a) Use only the feed-forward CCURU 104 process, where the CCURU 104 is only connected to the output of the A/D converter 102 and has no connection to the MUD 103 output. This necessitates that the CCURU 104 does not rely on MUD 103 processed output signals to perform the required Channelization Code but rather on signals preceding the MUD 103. For example, the MUD 103 could be considered as a device following a bank of Matched Filters/Rake receivers, while the CCURU following either the A/D converter 102 or the same Matched Filters/Rake receiver bank as the MUD 103. The Channelization Code Usage information could be retrieved by the various means described before. This configuration is applicable to both autonomously derived CCU data at the Remote Station without cooperation by the Base Station and cooperatively derived CCU data where Base Station relays some or all the information to the CCURU 104 and the CCURU 104 can derive any potentially additional code usage information locally. The advantage of this method is that it is not affected by a possible divergent behavior of the MUD 103. In case the MUD 103 diverges (falls into an unstable operating region), the feedback CCU information will become unreliable, which in turn will force the MUD 103 to continue outputting unreliable data. Irrespectively on how the MUD 103 operates, the feed-forward approach will always provide a reasonable estimate of the CCU information. The of feed forward methods where the channelization code usage information is estimated locally is that the estimates may not be as reliable as those provided by feedback based information albeit their non-always guaranteed stable behavior.

(b) A feedback only configuration where channelization code usage information is retrieved by examining the data estimation results at the output of the MUD 103. As an example, in case the CCU data is embedded into a physical channel, whether common or dedicated, the Remote Station could start by first retrieving the necessary CCU before the MUD 103 is set to become fully operational. Having the MUD 103 module operational would provide for more reliable CCU data, which in turn would make the MUD 103 more effective and the resulting CCU even more reliable. Here we have assumed that MUD 103 could operate on a single channel first (disabled) in order to retrieve the CCU information before setting the MUD 103 to operate on more channels.

(c) A joint feed-forward/feedback scheme would combine the best qualities of both ways (a) and (b) above. The MUD 103 could be kick-started by the feed-forward derived CCU data and then incorporate the MUD 103 output to the CCU data estimation. This configuration of CCU information estimation is applicable to both Remote Station autonomous and Base Station cooperative operational approaches. Operating on the raw data before being processed by the MUD 103 could first retrieve the CCU information. Subsequent convergence of the MUD 103 will provide cleaner signals for the CCURU 104 to operate upon. In both Remote Station autonomous and Base Station cooperative approaches, the feed-forward portion of the estimation could serve as a stabilization factor into the overall process. If the MUD 103 outputs are deemed unreliable, the feed forward portion of the estimation process could be given total control of the CCU data estimation and none to the feedback. The feedback portion could again be enabled once the MUD 103 is considered to operate reliably.

In case the Remote Station is not located in a soft-handover region, the CCU information for a single Base Station will only need to be derived. In the event where the Remote Station operates in the soft-handover region, the MUD is much more effective if the CCU for all Base Stations the Remote Station is in handover with, are known. In CDMA systems, it is more prevalent to implement soft-handover, where the same data is transmitted to the Remote Station from two or more Base Stations at the same time. The transmitted signals carrying are combined at the Remote Station in some appropriate manner (normally using a RAKE receiver) in order to obtain diversity gain. In order to realize these kinds of gains and at the same time remove unwanted interference for neighboring cells, the CCURU will need to derive the CCU data for all neighboring Base Stations.

Depending how the CCU is derived at the Remote Station, special provisions need to be taken at the Base Station. In case a special data channel is setup to relay the CCU data, the Base Station will need to form a CCU data packet at some update rate, and transmit that packet over that data channel. The CCU data may be retrieved from information located in buffers at the Base Stations, the RNCs or both. It is possible that some CCU data is located only at the Base Station as in the case of Base Station control on some channelization code assignments. In other cases, it is easier to receive the CCU data from the RNCs for the channelization code assignments made at the RNC locations. An efficient way would be to have a special module in each Node B to keep track of the channelization code set used by the Base Station at each instant whether the assignments are made locally at the Base Station or at the RNC level. In either case, this type of information is always available at the Base Station since it is where all the physical channels are formed. It is also reasonable to have dedicated communication between Base Stations and RNCs where CCU information is exchanged between different cells. In that case, it is possible for a Remote Station to receive all the relevant CCU data for all neighboring cells from a single (primary) cell. This would be advantageous since CCU data could then be transmitted via the most reliable Base Station the Remote Station is receiving from at any instant of time.

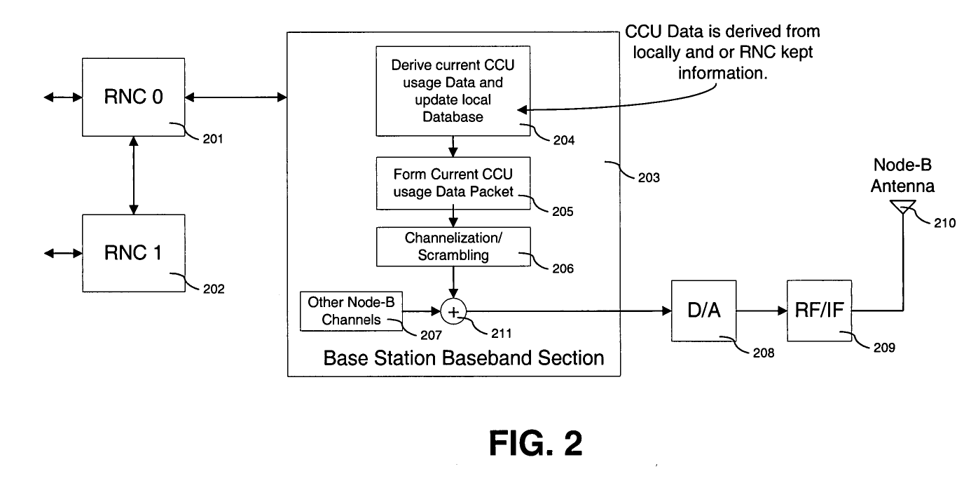

A Base Station system transmitting the CCU information on a unique downlink physical channel would need the modules and functionalities as shown in the functional schematic in FIG. 2. In FIG. 2, the functional entity 204 derives the CCU information by retrieving data from local databases and or RNC 201, 202 kept information. Depending on the specific operation of the system, some of the channelization code resource management is done on the RNC and some at the Base Station sites. The functional unit 204 could be periodically supplied this information from either other local to Base Station entities or entities located at the RNCs. This information will need to be updated at a reasonably fast rate in order for the Remote Stations to remove an interfering channel as early as possible. The local to Base Station channelization code usage information of the codes under direct control of the Base Station could be updated as soon as a new channelization code has been assigned or de-assigned. For channelization code usage information that reside at the RNC or at different Base Stations a data transport mechanism and a protocol will need to be setup so that all the necessary information will need to be collected and disseminated to the appropriate Base Stations. The collected channelization code usage information collected at functional unit 204 are packetized by functional unit 205 based on a previously setup frame structure known to the Remote Stations. The CCU packet information is then spread and scrambled by a unique channelization code and scrambles by the Base Station scrambling code. The resulting spread spectrum physical channel is added up with the rest of the physical channels 207 transmitted by the Base Station 203 on the downlink. The composite signal of all downlink physical channels is then filtered, D/A converted 208, RF/IF filtered 209 and transmitted from the Base Station 203 transmitting antenna 210.

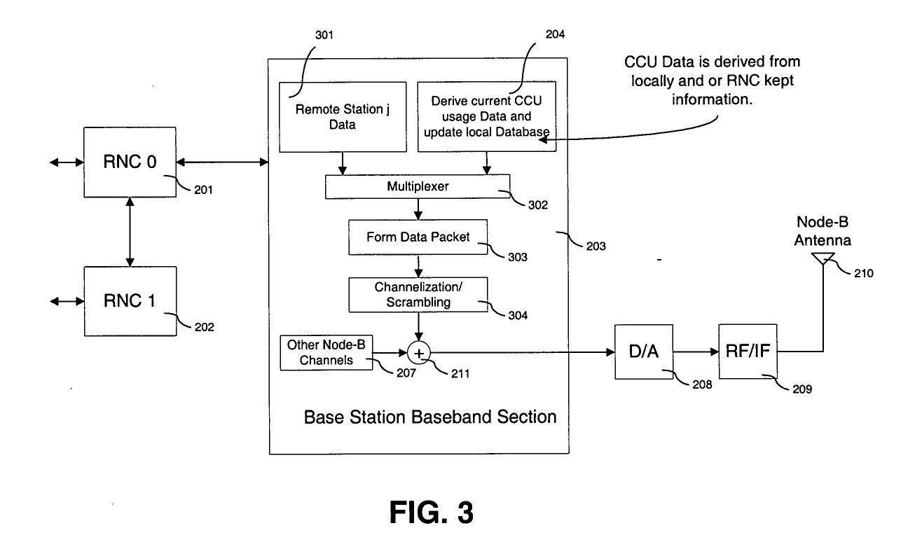

Another applicable Base Station functional configuration is as shown in FIG. 3. In FIG. 3, the Remote Station receives CCU data through signaling embedded in its normal communication channel using data multiplexing. Again, CCU data could be obtained locally at the Base Station 203 and/or with the cooperation of neighboring RNCs 201, 202. In FIG. 3, the information data for the Remote Station j 301 is multiplexed by multiplexer 302 with the CCU information data collected by functional unit 204 and packetized by functional unit 303. The resulting packets are spread by the Remote Station j specific channelization code and scrambled by the Base Station 203 scrambling code by functional unit 304. The resulting physical channel is then added to the rest of the downlink physical channels and transmitted from the Base Station 203 transmitting antenna 210 after the necessary filtering, D/A conversion 208 and RF/IF 209 filtering operations. The RNCs 201 and 202 would need to communicate channelization code usage information of neighboring Base Stations using a signaling channel and an appropriate protocol.

Having obtained the CCU data in some way, this data can now be used to efficiently implement different MUD structures. In some sense, the MUD operation from a communications point of view can be described as a linear matrix vector operation. This entails linear MUD structures. However, other nonlinear types of MUD structures are also applicable to the approach disclosed here and the invention is not limited to the use of linear MUD structures.

Let y represent the vector of the signal received at the Remote Station for all the time of interest. In the above, appropriate digitization of the received signal is assumed. The vector y can be expressed in a matrix vector form as
y=Gd+n, (1)
where, G is a matrix whose structure depends on the codes (i.e., physical channels) used by the primary and all neighboring Base Stations, the channel characteristics of all the received Base Stations (i.e., channel responses), the movement of the Remote Station, etc., d is their transmitted composite data information to all Remote Stations, and n is the received background noise at the Remote Station. The expression in EQ. 1 is meant to include only signals that have some non-negligible power to make a difference at the Remote Station receiver. Assuming the Remote Station knows all the information embedded in matrix G, the Remote Station can generate and process G locally. Having identified G, a variety of MUD approaches, which require previous knowledge of G, may be applied. In general, there are some optimum solutions to the system described in EQ.

1. The Minimum Mean Square Error (MMSE) MUD solution is given by
d_{MMSE}=[G⁺G+σ²I]⁻¹G⁺r, (2)
where, σ² is the variance of the background noise assuming it is of zero mean additive white Gaussian and the matrix I is an identity matrix of appropriate size. The decorrelator type MUD solution is given by
d_{DEC}=[G⁺G]⁻¹G⁺r. (3)
Various structures have been developed in dealing with inverting the above matrices depending on how the system is being operated.

In U.S. Pat. No. 05,757,791, a multi-stage multi-user detector structure is disclosed. As part of the disclosure here, a structure similar to that disclosed in the above patent will be disclosed. Techniques disclosed in this patent could all be used in the MUD disclosed here. In general, the disclosed structure in the above patent can be described by a simple algebraic matrix expression as,

$${\underline{d}}_{P\_MMSE} = {\sum }_{i = 0}^{Ns} {{\underline{W}}_{i} [ {G}^{+} G ]}^{i} {G}^{+} \underline{r} , \qquad ( 4 )$$

where d_{Pdi —}_{MMSE} is the estimated data based on this MUD structure denoted as Polynomial MMSE (P_MMSE), Wᵢ, I=0, . . . ,Ns, are diagonal matrices holding weights for weighting the outputs of each stage and Ns is the number of stages of the multistage MUD. The matrix G incorporates the channelization codes used, all filtering at the transmitter and receiver and all the channel effects among others. The multiplication of the received signal vector r by the matrix G⁺ defines the processing of r by filters matched to the channel (i.e., RAKE reception), the transmitting and receiving filters, the transmitted scrambling code, the channelization codes, etc. The vector G⁺r denotes the general operation of a Matched Filter receiver where the matching is done with respect to the received symbols. This MUD structure also discloses the regeneration of soft estimates of the transmitted data by the operation defined by GG⁺r by processing the vector G⁺r with G, which denotes filtering with the channel filters, the transmit and receiving filters, the various scrambling and channelization operations, among others. Processing GG⁺r by G⁺ is identical to that of processing r by the matrix G⁺ and completes the first stage of processing in the MUD receiver. In case a single stage is implemented only, the output of the first stage is linearly combined with the Matched Filter output to produce a better estimate of the transmitted user data.

In special cases when the system is operated in a synchronous manner, the matrix G could be considered as a block diagonal matrix. In such cases, the matrix defined by
R=G⁺G, (5)
could also be considered as a block diagonal matrix. Inverting R or R+σ² I is equivalent to inverting the block diagonal matrices.

In what follows the simple type of downlink transmissions and a preferred way to perform MUD at the Remote Station is shown. This case could be easily extended to include many different and realistic cellular communication scenarios and environments as in the multi-stage MUD structure defined in EQ. 4. A more descriptive analysis of this type of MUD structure can be found in the reference publications and patents. The case shown here is meant to disclose in simple terms the invention part that pertains to the implementation of simple MUD structures at the Remote Station.

Assume a Remote Station receives equal duration symbol-synchronous transmissions from two Base Stations and the two downlink channels are simple white Gaussian channels. It is also assumed that the symbols transmitted from the two Base Stations also arrive synchronously at the Remote Station. Since consecutive symbols are assumed to not overlap, only those being transmitted at a particular single symbol period will be considered. Then, the received signal vector could be expressed as
y=G₀d₀+G₁d₁+n, (6)

Where G₀ is the code matrix used by Base Station 0, G₁ is the code matrix used by Base Station 1, the data d₀ and d₁ are the data vectors transmitted by Base Station 0 and Base Station 1 respectively, and n is assumed to be a white gaussian background noise vector. EQ. 6 may again be expressed as in EQ. 1 by blocking the matrices G₀ and G₁ and vectors d₀ and d₁ together.

$$\underline{y} = [ \begin{matrix}{G}_{0} & {G}_{1}\end{matrix} ] [ \begin{matrix}{\underline{d}}_{0} \\ {\underline{d}}_{1}\end{matrix} ] + \underline{n} = G \underline{d} + \underline{n} \qquad ( 7 )$$

At this point, the method disclosed here makes use of a basic property normally held by downlink CDMA transmissions in cellular communication systems. This property pertains to the orthogonal transmission of data transmitted from each Base Station. Here it is assumed that over a single symbol period, all the symbols transmitted from a Base Station have the same processing gain or time duration of their channelization codes. The channelization codes can be assumed to be Walsh/Hadamard codes or a variation of them. Any code set will be applicable to the disclosed invention, however, some channelization code sets present certain computational advantages over other channelization code sets. The overall set of channelization codes transmitted by either of the two Base Stations in this example will be denoted by H. The signal received from Base Station 0 may then be described as,
r₀=C₀Hd (8)
Where H is the Walsh/Hadamard matrix of dimension equal to the symbol's processing gain, C₀ is a diagonal matrix denoting the scrambling code of Base Station 0 and d₀ is the data vector transmitted to all Remote Stations in the cell during that symbol period. For convenience, we will assume that H is a full Hadamard matrix and d₀ is appended with zeros for non-utilized codes (i.e., columns of the Walsh/Hadamard matrix). It is actually the identification of those un-utilized columns and the incorporation of that information to the MUD structure that is one of the main elements in the disclosed invention.

Therefore, r₀ could be expressed as

$${r}_{0} = [ \begin{matrix}{C}_{0 , 0} & & & \\ & {C}_{1 , 1} & 0 & \\ & 0 & ⋰ & \\ & & & {C}_{K - 1 , K - 1}\end{matrix} ] [ \begin{matrix}\underline{{h}_{0}} & \underline{{h}_{1}} & ⋯ & \underline{{h}_{K - 1}}\end{matrix} ] [ \begin{matrix}{d}_{00} \\ {d}_{01} \\ ⋮ \\ {d}_{0 J} \\ ⋮ \\ 0\end{matrix} ] \qquad ( 9 )$$

The location of the zeros is not necessarily as shown grouped at the end of the vector d₀. Using the above expressions, the received vector at the Remote Station may be expressed as

$$\underline{y} = [ \begin{matrix}{C}_{0} H & {C}_{1} H\end{matrix} ] [ \begin{matrix}{\underline{d}}_{0} \\ {\underline{d}}_{1}\end{matrix} ] + \underline{n} = [ \begin{matrix}{C}_{0} & {C}_{1}\end{matrix} ] [ \begin{matrix}H & 0 \\ 0 & H\end{matrix} ] [ \begin{matrix}{\underline{d}}_{0} \\ {\underline{d}}_{1}\end{matrix} ] + \underline{n} \qquad ( 10 )$$

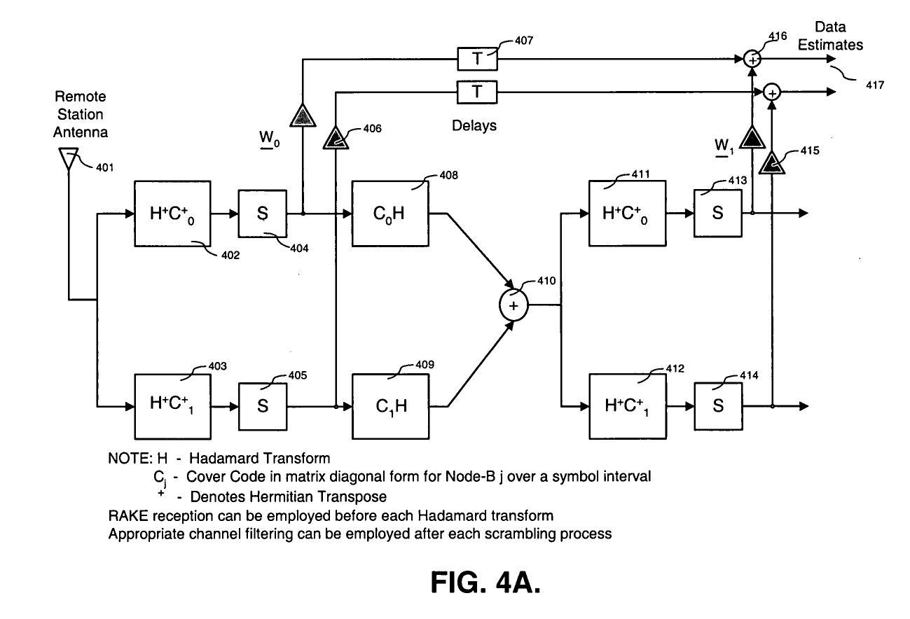

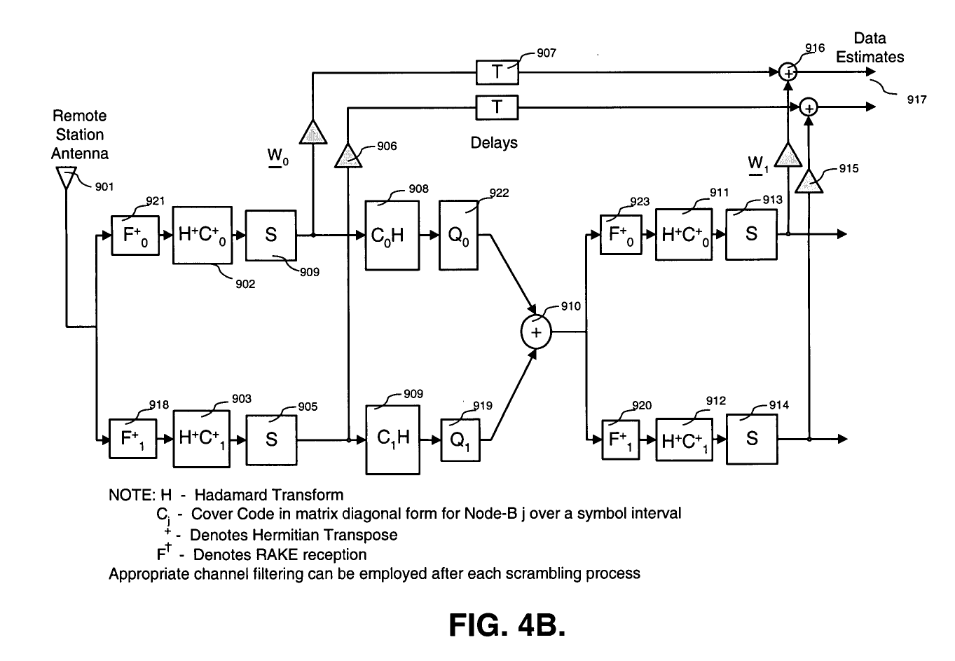

The expressions above show the structure of the received signals. It is now easy to move to a Base Station-to-Base Station asynchronous case while keeping symbols from the same Base Station still being transmitted orthogonally. Following the method defined in U.S. Pat. No. 0,575,7791, the MUD structure shown in FIG. 4A can be obtained. Here, if the channels were to be considered as time dispersive, additional filtering such as RAKE reception would have to be employed.

The functionality of the modules S 404, 405, 413 and 414 is to zero-out outputs of the preceding modules that are known to be zero. The module H⁺C₀⁺ 402 signifies the demodulation of the data received from Base Station 0, the module H⁺C₁⁺ 403 signifies the demodulation of the data received from Base Station 1. Likewise, C₀H 408 and C₁ H 409 define the modulator functionalities for Base Station 0 and Base Station 1 respectively. Thus, the overall process defined in FIG. 4A is to demodulate all the data from the two Base Stations, zero out known non-transmitted data, and submit the resulting soft vector to the next stage and to a linear combiner. The demodulation process described here is linear. A non-linear decision device can be easily incorporated at the outputs of the demodulators. These nonlinear decision devices could use prior or side information to provide for a better estimate of the transmitted data. Non-linear devices that could be used here are tangent hyperbolic type decision devices.

At the next stage, the estimated received data from each Base Station are again re-modulated and added by adder 410. This recreates the process of data modulation at the two Base Stations, transmission through the two channels and reception at the Remote Station antenna. Demodulators 411 and 412 carry out the process of demodulation of the resulting vector, and the switches 413 and 414 carry out the selection of known non-zero data. The resulting output vector is now output to the linear combiner to be combined with first stage demodulated output.

The linear combination of the two outputs is now a better estimate of the transmitted data. Choosing the proper weights have been the focus of much research and a method is described in the U.S. Pat. No. 0,575,7791. Muller and Verdu also presented a formula in the paper “Design and Analysis of Low-Complexity Interference Mitigation on Vector Channels” published in the IEEE Journal on Selected Areas in Communications, vol. 19, no 8, Aug. 2001, in which the weights can be set by knowing the overall system load and the underlying noise variance.

A multi-stage MUD receiver structure incorporating channel dispersion, transmitting and receiving filtering is shown in FIG. 4B. Here the exact structure of that in FIG. 4A is replicated with filters F⁺ᵢ, i=0,1, denoting either a pair of filters each matched to the corresponding one of the two channels from the Base Stations to the Remote Station, or some type of equalizing filters performing equalization corresponding to the two channels from the two Base Station to the Remote Station. The transmitting and receiving spectral shaping filtering operations can be absorbed into the channel or equalizer filtering. The filters F⁺ᵢ, i=0,1, when used as channel matched filters are in essence performing RAKE receiver filtering operations corresponding to the two channels from the two Base Stations to the Remote Station. The filters represented by the two filters Qᵢ, i=0,1, are estimates of the channel filters from the two Base Stations to the Remote Station respectively. Therefore, the structure in FIG. 4B could either operate with F⁺ⁱ, i=0,1, being the two RAKE receivers and Qᵢ, i=0,1, their corresponding channel filters for the two channels from the two Base Stations to the Remote Station, or F⁺ᵢ, i=0,1, being the equalizer filters and Qᵢ, i=0,1, their channel filters corresponding to the two channels from the two Base Stations to the Remote Station.

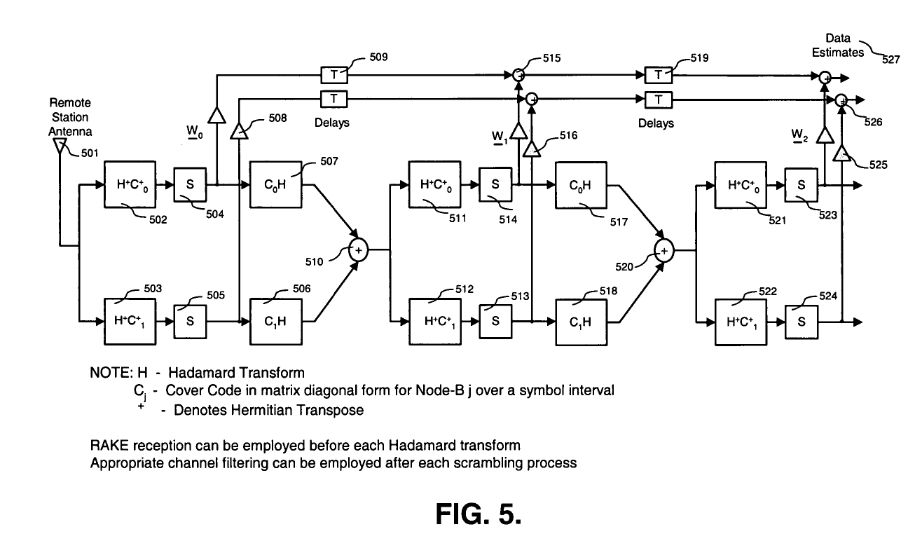

The structure shown in FIG. 4A can be extended to include more stages as shown by example in FIG. 5.

In FIG. 4B, the multi-stage MUD receiver structure of FIG. 4A incorporating the RAKE receiver and channel filtering operations in the receiver and signal regeneration processing blocks respectively is shown. The received signal at antenna 901 is processed by filters F₀⁺ 921 and F1⁺ 918 which are either RAKE receiver processing blocks or equalizers corresponding to each of the two channels from the two Base Stations to the Remote Station respectively. The respective RAKE receiver or equalizer outputs or F₀⁺ 921 and F₁⁺ 918 are each descrambled by their corresponding Base Station scrambling codes and processed by Walsh/Hadamard transformers as shown in blocks 902 and 903. The S modules 909 and 905 process each of the transform outputs 902 and 903 respectively. The two S modules 909 and 905 zero out the transformer outputs which are determined, either through signaling or through local processing, not to contain signal energy. That is, there was no spread spectrum signals transmitted on the corresponding to those transform outputs code vectors. The remaining non-zero outputs from the two transformers are input to the first stage of the multistage MUD detector and multiplied by two sets of weight vectors 906 to produce two sets of weighted Matched Filter/equalizer outputs. There is one set of weight values for each of the transformer outputs. The two sets of weighted Matched Filter/equalizer outputs are delayed by corresponding delays 907 and summed with the weighted outputs of the first stage using summers 916. The two sets of inputs to the first stage are each processed by Walsh/Hadamard transformers in 908 and 909 and subsequently scrambled by their corresponding Base Station scrambling codes also in 908 and 909. The two outputs of 908 and 909 are regenerated signal estimates of the transmitted signals from the two corresponding Base Stations. The filter blocks 922 and 919 filter the signal outputs from 908 and 909 respectively, each of the filter operations in 922 and 919 correspond to the channel filtering (i.e., dispersion) corresponding to the two channels from the two Base Stations to the Remote. The resulting outputs of the two channel filters are summed by summer 910 to produce an estimate of the composite signal waveform received at antenna 901. The processing from blocks 923 and 920 to the S modules 913 and 914 is the same as the processing from blocks 921 and 918 to the S modules 909 and 905. The outputs of the S modules 913 and 914 are the output of the first stage of the MUD detector and are weighted by two sets of weights 915 each corresponding to the signals received from the two Base Stations. The weighted outputs of the first stage are linearly combined with the delayed by 907 versions of the previously weighted Matched Filter/equalizer outputs. The resulting two outputs in 917 are the outputs of a single stage MUD detector and correspond to the data transmitted by the two Base Stations respectively. Clearly, if the Remote Station is only required to estimate data from one Base Station only, the corresponding processing that is unnecessary to forming those estimates need not be carried out.

The processing as described in FIG. 4B can be expanded to incorporate more than two Base Stations if necessary. It is also possible to operate on a single Base Station, however, a direct channel equalizer to equalize the single channel from the Base Station to the Remote Station might be a simpler and a just as efficient detector.

There are two main properties of the above structure that make the MUD structure disclosed above feasible to be incorporated at the Remote Station. The first is the use of Walsh/Hadamard transforms to demodulate and re-modulate received and estimated data. This reduces the system complexity to a number of Walsh/Hadamard transforms per symbol interval. Since Hadamard transforms can be carried out by additions only, the disclosed structure is within the capabilities of today's electronic devices. The second property is the use of the CCU information to zero out the outputs at each stage when known that data have not been transmitted over certain channelization codes.

The above-defined MUD structure can be used with any type of cellular CDMA system that utilizes orthogonal transmissions on the downlink. If the matrices H are replaced by general matrices denoting the Channelization codes used by different Base Stations, the orthogonality constraint on the downlink can be removed as well. However, the complexity of performing matrix vector multiplications in such a case could be very complex depending on the size of the matrices. Furthermore, the data could be transmitted with different and variable spreading factors. Appropriate delay buffers will need to be incorporated at the inputs or outputs of the selectors S. This will allow the re-alignment of the estimated data due to their different delays through the different demodulators. Clearly all channel and filtering effects can be easily incorporated into the system. Ways of doing that are also explained in the above-mentioned patent and referenced papers. As previously explained in other patents and published literature and assumed to be as part of a realistic operation of the disclosed method, the channel effects will need to be incorporated into the disclosed method. For example, since normally, the transmissions from each Base Station are over time dispersive (multipath) channels the received at a Remote Station codes dispersed in time, the received codes can be considered as a weighted sum of delayed versions of the transmitted codes. In spread spectrum systems, this channel dispersion is normally dealt with the use of RAKE receivers. In the case multiple orthogonal codes are to be received using a Walsh/Hadamard transform, the multipath components can be first RAKED by a RAKE receiver to coherently combine weighted version of the multipath components followed by the Walsh/Hadamard transform.

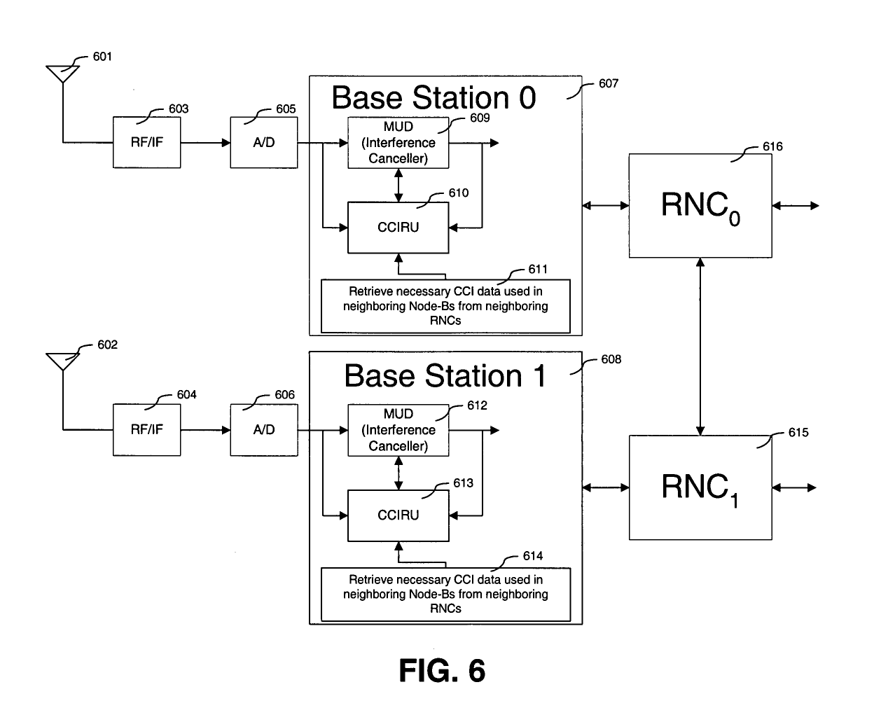

The above teachings could be used to improve upon MUD structures as used in Base Stations. It is clear that having information about the codes of all the users being received at a Base Station at some non-negligible power level would be of advantage to the MUD process. Therefore, as part of the disclosure here, a signaling capability between RNCs and Base Stations relaying the current channelization code usage information on the uplink is disseminated between neighboring Base Stations. The functional schematic shown in FIG. 6, describes the signaling routes and the use of CCU at different Base Stations. The overall concept described before for MUD at the Remote Station could be applied to the Base Stations. In FIG. 6, the Channelization Code Usage at different Base Stations is retrieved at each Base Station through communications between the neighboring RNCs 615 and 616 and Base Stations 607 and 608. Functional Units 611 and 614 in each Base Station are responsible for retrieving the uplink CCU information at the neighboring Base Stations. Each Base Station 607 and 608 sends local CCU information to its corresponding RNC 616 and 615, and the RNCs relay them to the appropriate Base Stations in a timely manner following predefined protocols. This CCU information is relayed to the local MUD at the Base Station in order for the MUD to recreate the multi-user interference in a manner similar to the one shown in the Remote Station case. Similar MUD operations and CCU derivations disclosed for the operation of the Remote Stations apply to the MUD operations at the Base Station sites. That is, the CCURUs 610 and 613 can retrieve the CCU information from the functional blocks 611 and 614 respectively, from signals arriving at the Base Station antennas 601 and 602 and from the processed signal outputs of the MUDs 609 and 612. Using uplink CCU information from neighboring Base Stations could greatly improve the performance of the MUD at a Base Station. It will have to be assumed that CCU information at neighboring Base Stations already known at a specific Base Station need not be sent. This case arises in soft-handoff situations where the uplink channelization and scrambling code used by a Remote Station is shared by a number of neighboring Base Stations since they are all receiving the same transmission from that Remote Station.

1. A method for performing multi-user detection at a Remote Station in a wireless communication system comprised of a plurality of Remote Stations and at least one Base Station, said method comprising the steps of:
packetizing at a Base Station data comprised of at least spreading code information data for a least one of plurality of spreading codes as packet data;
spreading said packet data by a first spreading code to form a spread spectrum signal;
transmitting said spread spectrum signal over the air using radio waves;
receiving at a Remote Station said spread spectrum signal as a received spread spectrum signal;
dispreading said received spread spectrum signal using first spreading code to produce a despread spread spectrum signal;
demodulating said despread spread spectrum signal to produce received spreading code information;
using said received spreading code information to produce at least one of said plurality of spreading codes as locally generated spreading codes;
receiving at said remote station a composite spread spectrum signal comprised of a plurality of user spread spectrum signals;
dispreading at said remote station said composite spread spectrum signal using said locally generated spreading codes to produce at least one of despread user spread spectrum signals,
filtering said despread user spread spectrum signals to produce signal values;
inputting said signal values to a multi-user detector;
whereby the multi-user detector is used to detect user data received at said Remote Station as said composite spread spectrum signal.

2. The method in 1, wherein said packet data is transmitted over a dedicated channel.

3. The method in 1, wherein said packet data is transmitted over a common channel.

4. A method for performing multi-user detection of a composite spread spectrum signal at a Remote Station, said signal comprising a plurality of spread spectrum signals, said spread spectrum signals spread by a plurality of spread spectrum codes, wherein spread spectrum code information data of at least one of the plurality of spread spectrum codes is contained in at least one of said spread spectrum signals, said method comprising the steps of:
receiving said composite spread spectrum signal;
dispreading and demodulating at least one of said spread spectrum signals containing said spread spectrum code information data to produce received spread spectrum code information data;
using said received spread spectrum code information data to produce dispreading spread spectrum codes;
dispreading said composite spread spectrum signal using said dispreading spread spectrum codes to produce despread spread spectrum signals;
filtering said despread spread spectrum signals to produce signal values;
inputting said signal values to said multi-user detector.

5. The method in claim 4, further comprising the step of:
inputting said received spread spectrum code information data to said multi-user detector.

6. A method for performing multi-user detection of a composite spread spectrum signal at a Remote Station, said composite spread spectrum signal comprising a plurality of spread spectrum signals received from a first Base Station, said spread spectrum signals spread by a plurality of spread spectrum codes, wherein spread spectrum code information data about at least one of the plurality of spread spectrum codes is contained in at least one of said spread spectrum signals, said method comprising the steps of:
receiving said composite spread spectrum signal;
descrambling, despreading and demodulating at least one of said spread spectrum signals containing information about the plurality of said spread spectrum codes to produce received spread spectrum code information data;
descrambling said composite spread spectrum signal by first Base Station descrambling code to generate a first descrambled composite spread spectrum signal;
transforming said first descrambled composite spread spectrum signal using Walsh/Hadamard transform means to produce a first plurality of transformed signals values;
selecting a subset of said first plurality of transformed signal values using said received spread spectrum code information data to form a first subset of plurality of transformed spread spectrum values.

7. The method for performing multi-user detection of a composite spread spectrum signal at a Remote Station of claim 6, further comprising:
weighting said first subset of plurality of transformed spread spectrum values with a corresponding first plurality of weights to produce a first plurality of weighted values;
transforming first subset of plurality of transformed spread spectrum values using Walsh/Hadamard transform means to produce a first reconstructed unscrambled composite spread spectrum signal;
scrambling said first reconstructed unscrambled composite spread spectrum signal by first Base Station descrambling code to generate a first reconstructed composite spread spectrum signal;
descrambling said first reconstructed composite spread spectrum signal by first Base Station descrambling code to generate a second descrambled composite spread spectrum signal;
transforming said second descrambled composite spread spectrum signal using Walsh/Hadamard transform means to produce a second plurality of transformed signals values;
selecting a subset of said second plurality of transformed signal values using said received spread spectrum code information data to form a second subset of plurality of transformed spread spectrum values;
weighting said second subset of plurality of transformed spread spectrum values with a corresponding second plurality of weights to produce a second plurality of weighted values;
delaying said first plurality of weighted values with delay means and adding said first plurality of weighted values with said second plurality of weighted values to produce a plurality of estimated signal values;
decoding said plurality of estimated signal values to produce estimated data.

8. A method for performing multi-user detection of a composite spread spectrum signal at a Remote Station, said signal comprising a plurality of spread spectrum signals received from a first Base Station and a second Base Station, said plurality of spread spectrum signals spread by a plurality of spread spectrum codes, wherein spread spectrum code information data of at least one of the plurality of spread spectrum codes is contained in at least one of said plurality of spread spectrum signals, said method comprising the steps of:
receiving said composite spread spectrum signal;
descrambling, despreading and demodulating at least one of said spread spectrum signals containing information about the plurality of said spread spectrum codes to produce received spread spectrum code information data;
descrambling said composite spread spectrum signal by first Base Station descrambling code to generate a first descrambled first_Base_Station composite spread spectrum signal;
transforming said first descrambled first_Base_Station composite spread spectrum signal using Walsh/Hadamard transform means to produce a first plurality of first_Base_Station transformed signals values;
selecting a subset of said first plurality of first_Base_Station transformed signal values using said received spread spectrum code information data to form a first subset of plurality of first_Base_Station transformed spread spectrum values;
descrambling said composite spread spectrum signal by second Base Station descrambling code to generate a first descrambled second_Base_Station composite spread spectrum signal;
transforming said first descrambled second_Base_Station composite spread spectrum signal using Walsh/Hadamard transform means to produce a first plurality of second_Base_Station transformed signals values;
selecting a subset of said first plurality of second_Base_Station transformed signal values using said received spread spectrum code information data to form a first subset of plurality of second_Base_Station transformed spread spectrum values.

9. The method for performing multi-user detection of a composite spread spectrum signal at a Remote Station of claim 8, further comprising:
weighting said first subset of plurality of first_Base_Station transformed spread spectrum values with a corresponding first plurality of first_Base_Station weights to produce a first plurality of first_Base_Station weighted values;
delaying said first plurality of first_Base_Station weighted values with delay means to produce a first plurality of first Base_Station delayed values;
transforming said first subset of plurality of first_Base_Station transformed spread spectrum values using Walsh/Hadamard transform means to produce a first reconstructed unscrambled first_Base_Station composite spread spectrum signal;
scrambling said first reconstructed unscrambled first_Base_Station composite spread spectrum signal by first Base Station descrambling code to generate a first reconstructed first_Base_Station composite spread spectrum signal;
transforming said first subset of plurality of second_Base_Station transformed spread spectrum values using Walsh/Hadamard transform means to produce a first reconstructed unscrambled second_Base_Station composite spread spectrum signal;
scrambling said first reconstructed unscrambled second_Base_Station composite spread spectrum signal by first Base Station descrambling code to generate a first reconstructed second_Base_Station composite spread spectrum signal;
adding said first reconstructed first_Base_Station composite spread spectrum signal with said first reconstructed second_Base_Station composite spread spectrum signal to produce a first reconstructed composite spread spectrum signal;
descrambling said first reconstructed first_Base_Station composite spread spectrum signal by first Base Station descrambling code to generate a second descrambled first_Base_Station composite spread spectrum signal;
transforming said second descrambled first_Base_Station composite spread spectrum signal using Walsh/Hadamard transform means to produce a second plurality of first_Base_Station transformed signals values;
selecting a subset of said second plurality of first_Base_Station transformed signal values using said received spread spectrum code information data to form a second subset of plurality of first_Base_Station transformed spread spectrum values;
weighting said second subset of plurality of first_Base_Station transformed spread spectrum values with a corresponding second plurality of first_Base_Station weights to produce a second plurality of first_Base_Station weighted values;
adding said first plurality of first_Base_Station delayed values with said second plurality of first_Base_Station weighted values to produce a plurality of estimated first_Base_Station signal values.

10. The method for performing multi-user detection of a composite spread spectrum signal at a Remote Station of claim 9, further comprising:
weighting said first subset of plurality of second_Base_Station transformed spread spectrum values with a corresponding first plurality of second_Base_Station weights to produce a first plurality of second_Base_Station weighted values;
delaying said first plurality of second_Base_Station weighted values with delay means to produce a first plurality of second_Base_Station delayed values;
descrambling said first reconstructed second_Base_Station composite spread spectrum signal by second Base Station descrambling code to generate a second descrambled second_Base_Station composite spread spectrum signal;
transforming said second descrambled second_Base_Station composite spread spectrum signal using Walsh/Hadamard transform means to produce a second plurality of second_Base_Station transformed signals values;
selecting a subset of said second plurality of second_Base_Station transformed signal values using said received spread spectrum code information data to form a second subset of plurality of second_Base_Station transformed spread spectrum values;
weighting said second subset of plurality of second_Base_Station transformed spread spectrum values with a corresponding second plurality of second_Base_Station weights to produce a second plurality of second_Base_Station weighted values;
adding said first plurality of first_Base_Station delayed values with said second plurality of second_Base_Station weighted values to produce a plurality of estimated second_Base_Station signal values.

11. A method for performing multi-user detection of a composite spread spectrum signal at a Remote Station, said signal comprising a plurality of spread spectrum signals received from a first Base Station and a second Base Station, said plurality of spread spectrum signals spread by a plurality of spread spectrum codes, wherein spread spectrum code information data of at least one of the plurality of spread spectrum codes is contained in at least one of said plurality of spread spectrum signals, said method comprising the steps of:
receiving said composite spread spectrum signal;
descrambling, despreading and demodulating at least one of said spread spectrum signals containing information about the plurality of said spread spectrum codes to produce received spread spectrum code information data;
filtering said composite spread spectrum signal by first filter to produce a first filtered composite spread spectrum signal;
descrambling said first filtered composite spread spectrum signal by first Base Station descrambling code to generate a first descrambled first_Base_Station composite spread spectrum signal;
transforming said first descrambled first_Base_Station composite spread spectrum signal using Walsh/Hadamard transform means to produce a first plurality of first_Base_Station transformed signals values;
selecting a subset of said first plurality of first_Base_Station transformed signal values using said received spread spectrum code information data to form a first subset of plurality of first_Base_Station transformed spread spectrum values;
filtering said composite spread spectrum signal by second filter to produce a second filtered composite spread spectrum signal;
descrambling said second filtered composite spread spectrum signal by second Base Station descrambling code to generate a first descrambled second_Base_Station composite spread spectrum signal;
transforming said first descrambled second_Base_Station composite spread spectrum signal using Walsh/Hadamard transform means to produce a first plurality of second_Base_Station transformed signals values;
selecting a subset of said first plurality of second_Base_Station transformed signal values using said received spread spectrum code information data to form a first subset of plurality of second_Base_Station transformed spread spectrum values;

12. The method in claim 11, wherein said first filter is an equalizer filter and said second filter is an equalizer filter.

13. The method in claim 11, wherein said first filter is a rake receiver filter and said second filter is a rake receiver filter.

14. The method for performing multi-user detection of a composite spread spectrum signal at a Remote Station of claim 11, further comprising:
weighting said first subset of plurality of first_Base_Station transformed spread spectrum values with a corresponding first plurality of first_Base_Station weights to produce a first plurality of first_Base_Station weighted values;
delaying said first plurality of first_Base_Station weighted values with delay means to produce a first plurality of first_Base_Station delayed values;
transforming said first subset of plurality of first_Base_Station transformed spread spectrum values using Walsh/Hadamard transform means to produce a first reconstructed unscrambled first_Base_Station composite spread spectrum signal;
scrambling said first reconstructed unscrambled first_Base_Station composite spread spectrum signal by first Base Station descrambling code to produce a first reconstructed first_Base_Station composite spread spectrum signal;
filtering said first reconstructed first_Base_Station composite spread spectrum signal by third filter to produce a first reconstructed first_Base_Station filtered composite spread spectrum signal;
transforming said first subset of plurality of second_Base_Station transformed spread spectrum values using Walsh/Hadamard transform means to produce a first reconstructed unscrambled second_Base_Station composite spread spectrum signal;
scrambling said first reconstructed unscrambled second_Base_Station composite spread spectrum signal by first Base Station descrambling code to generate a first reconstructed second_Base_Station composite spread spectrum signal;
filtering said first reconstructed second_Base_Station composite spread spectrum signal by fourth filter to produce a first reconstructed second_Base_Station filtered composite spread spectrum signal;
adding said first reconstructed first_Base_Station filtered composite spread spectrum signal with said first reconstructed second_Base_Station filterd composite spread spectrum signal to produce a first reconstructed composite spread spectrum signal;
filtering said first reconstructed composite spread spectrum signal with a fifth filter to produce a second reconstructed first_Base_Station filtered composite spread spectrum signal;
descrambling said second reconstructed first_Base_Station filtered composite spread spectrum signal by first Base Station descrambling code to generate a second descrambled first_Base_Station composite spread spectrum signal;
transforming said second descrambled first_Base_Station composite spread spectrum signal using Walsh/Hadamard transform means to produce a second plurality of first_Base_Station transformed signals values;
selecting a subset of said second plurality of first_Base_Station transformed signal values using said received spread spectrum code information data to form a second subset of plurality of first_Base_Station transformed spread spectrum values;
weighting said second subset of plurality of first_Base_Station transformed spread spectrum values with a corresponding second plurality of first_Base_Station weights to produce a second plurality of first_Base_Station weighted values;
adding said first plurality of first_Base_Station delayed values with said second plurality of first_Base_Station weighted values to produce a plurality of estimated first_Base_Station signal values.

15. The method in claim 14, wherein said first filter is an equalizer filter, said second filter is an equalizer filter, said third filter is a rake receiver filter, said fourth filter is a rake receiver filter and said fifth filter is an equalizer filter.

16. The method in claim 14, wherein said first filter is a rake receiver filter, said second filter is a rake receiver filter, said third filter is a channel filter, and said fourth filter is a channel filter, and said fifth filter is rake receiver filter.

17. The method for performing multi-user detection of a composite spread spectrum signal at a Remote Station of claim 14, further comprising:
weighting said first subset of plurality of second_Base_Station transformed spread spectrum values with a corresponding first plurality of second_Base_Station weights to produce a first plurality of second_Base_Station weighted values;
delaying said first plurality of second_Base_Station weighted values with delay means to produce a first plurality of second_Base_Station delayed values;
filtering said first reconstructed composite spread spectrum signal with a sixth filter to produce a second reconstructed second_Base_Station filtered composite spread spectrum signal;
descrambling said second reconstructed second_Base_Station filtered composite spread spectrum signal by second Base Station descrambling code to generate a second descrambled second_Base_Station composite spread spectrum signal;
transforming said second descrambled second_Base_Station composite spread spectrum signal using Walsh/Hadamard transform means to produce a second plurality of second_Base_Station transformed signals values;
selecting a subset of said second plurality of second_Base_Station transformed signal values using said received spread spectrum code information data to form a second subset of plurality of second_Base_Station transformed spread spectrum values;
weighting said second subset of plurality of second_Base_Station transformed spread spectrum values with a corresponding second plurality of second_Base_Station weights to produce a second plurality of second_Base_Station weighted values;
adding said first plurality of first_Base_Station delayed values with said second plurality of second_Base_Station weighted values to produce a plurality of estimated second_Base_Station signal values.

18. The method in claim 17, wherein said first filter is an equalizer filter, said second filter is an equalizer filter, said third filter is a rake receiver filter, said fourth filter is a rake receiver filter, said fifth filter is an equalizer filter, and said sixth filter is an equalizer filter.

19. The method in claim 17, wherein said first filter is a rake receiver filter, said second filter is a rake receiver filter, said third filter is a channel filter, and said fourth filter is a channel filter, said fifth filter is rake receiver filter and said sixth filter is a rake receiver filter.

20. A method for performing multi-user detection at a first Base Station in a wireless communication system comprised of a plurality of Remote Stations and at least said first Base Station, a second Base Station, and a radio network controller, first Base Station and Second Base Station connected to radio network controller, said method comprising the steps of:
receiving at said first Base Station a first composite spread spectrum signal comprising a plurality of first spread spectrum signals, said plurality of first spread spectrum signals spread by a plurality of first spread spectrum codes;
receiving at said second Base Station a second composite spread spectrum signal comprising a plurality of second spread spectrum signals, said plurality of second spread spectrum signals spread by a plurality of second spread spectrum codes;
sending periodically second spread spectrum code information about said second plurality of spread spectrum codes from said radio network controller to said first Base Station;
generating said first Base Station at least one second spread spectrum code of said plurality of second spread spectrum codes using said second spread spectrum code information;
despreading at least one of said first plurality of spread spectrum signals using said second spread spectrum code to produce a first Base Station second despread spread spectrum signal;
filtering said first Base Station second despread spread spectrum signal to produce a first Base Station second signal value;
inputting said first Base Station second signal value to a multi-user detector.

21. The method of claim 20, further comprising:
sending periodically second spread spectrum code information about said second plurality of spread spectrum codes from said second Base Station to said radio network controller.

22. The method of claim 20, further comprising:
processing at first Base Station received said first composite spread spectrum signal to produce said spread spectrum code information for at least one of said second plurality of spread spectrum codes.
sending periodically second spread spectrum code information about said second plurality of spread spectrum codes from said second Base Station to said radio network controller.

23. A method for performing multi-user detection at a first Base Station in a wireless communication system comprised of a plurality of Remote Stations and at least said first Base Station, a second Base Station, a first radio network controller and a second radio network controller, first Base Station connected to first radio network controller, second Base Station connected to second radio network controller and first radio network controller connected to second radio network controller, said method comprising the steps of:
receiving at said first Base Station a first composite spread spectrum signal comprising a plurality of first spread spectrum signals, said plurality of first spread spectrum signals spread by a plurality of first spread spectrum codes;
receiving at said second Base Station a second composite spread spectrum signal comprising a plurality of second spread spectrum signals, said plurality of second spread spectrum signals spread by a plurality of second spread spectrum codes;
sending periodically second spread spectrum code information about said second plurality of spread spectrum codes from said second radio network controller to said first Base Station through said first radio network controller;
generating said first Base Station at least one second spread spectrum code of said plurality of second spread spectrum codes using said second spread spectrum code information;
despreading at least one of said first plurality of spread spectrum signals using said second spread spectrum code to produce a first Base Station second despread spread spectrum signal;
filtering said first Base Station second despread spread spectrum signal to produce a first Base Station second signal value;
inputting said first Base Station second signal value to a multi-user detector.

24. The method of claim 23, further comprising:
sending periodically second spread spectrum code information about said second plurality of spread spectrum codes from said second Base Station to said radio network controller.

25. The method of claim 23, further comprising:
processing at first Base Station received said first composite spread spectrum signal to produce said spread spectrum code information for at least one of said second plurality of spread spectrum codes.
